(19) United States
(12) Patent Application Publication
(10) Pub. No.: US 2017/0325112 A1
(43) Pub. Date: Nov. 9, 2017

(54) COMPUTER IMPLEMENTED METHOD AND COMPUTER PROGRAMS FOR DETERMINING NETWORK QUALITY INDICATORS

(71) Applicant: TELEFONICA DIGITAL ESPAÑA, S.L.U., Madrid (ES)

(72) Inventors: Neystadt JOHN (EUGENE), Kfar-Saba (IL); Jorge SERNA POZUELO, Madrid (ES)

(73) Assignee: TELEFONICA DIGITAL ESPANA, S.L.U., Madrid (ES)

(21) Appl. No.: 15/524,480

(22) PCT Filed: Nov. 2, 2015
(86) PCT No.: PCT/EP2015/075459

§ 371 Date: May 4, 2017

(30) Foreign Application Priority Data
Nov. 5, 2014 (EP) 14382439.9
Nov. 28, 2014 (EP) 14382482.9

(51) Int. Cl. H04W 24/08

(52) U.S. Cl. CPC H04W 24/08

(57) ABSTRACT

The method comprising: performing a communication call between a first user (B) having a mobile device (H) with a communication application (D) installed therein which is connected to a VoIP communication service (F) through a communication network with a second user (A) via said communication service (F); and computing, based on information extracted from the communication call, by means of executing an algorithm running in a processor, a quality indicator descriptive of technical conditions of said communication network used for performing the communication call, wherein said information is extracted from the communication call by the communication application (D) or by the communication service (F) and includes an identifier of the communication network used, or location information of the mobile device (H) during the communication call, and quality parameters related to the communication call.

### FIELD OF THE INVENTION

The present invention generally relates to mobile communications. In particular, the invention relates to a computer implemented method and computer programs products for determining network quality indicators, so that the computed network indicators can be used for automatically configure user preferences for receiving/performing communication calls, via a VoIP or via a PSTN network.

### BACKGROUND OF THE INVENTION

Mobile communication applications, such as Skype®, Viber®, Line®, Tu Go®, provide an ability for receiving incoming communication calls via mobile application, using a Voice/Video Over IP (VoIP) interface (such as Session Initiation Protocol (SIP)), in addition to communication device OS ability to receive native mobile networks call over GSM, VoLTE (Voice over LTE) or other protocols. A key aspect influencing user experience is for communication services to decide whether to route an incoming call to a communication device via native (aka Public Switched Telephone Network (PSTN)), to the Communication Application via VoIP interface or both.

Communication Services allow users to manage their preferences on whether to receive calls via VoIP or PSTN network on their mobile devices which they are connected to.

U.S. Pat. No. 8,457,606 B2 discloses different techniques for allowing choosing among different methods to terminate a call (conventional cellular networks, VoIP calls over non-cellular networks, VoIP calls over cellular data networks, etc.). However, nor in said US patent neither in any other document, a method is provided for determining/computing, the quality of communication networks in order to help users in deciding their preferences for receiving/performing communication calls.

### SUMMARY OF THE INVENTION

Embodiments of present invention provides methods and computer programs for determining network quality indicators, based on past calls of a user with other users of a communication service, so that, particularly, the computed network quality indicators may be used to automatically configure user preferences for receiving/performing calls via VoIP (e.g. over WiFi) or as a native call via PSTN network.

To that end, according to an aspect of the invention a computer implemented method for determining network quality indicators is provided, said method comprising performing a communication call between a first user having a mobile device with a communication application installed therein which is connected to a VoIP communication service through a communication network such as a wireless network with a second user via the communication service; and computing, based on information extracted from said at least one communication call, by means of executing an algorithm running in a processor, a quality indicator descriptive of technical conditions (i.e. descriptive of the goodness of the network in terms of good QoS, no distortion or interferences, etc.) of the communication network used for performing the at least one communication call.

According to the invention said information can be extracted either by the communication application or, alternatively, by the communication service, and principally includes an identifier of the communication network, or location information of the mobile device during the communication call, and quality parameters related to the performed communication call. For instance, the quality parameters can include at least one of: the average network signal strength during the communication call, in case of a wireless network; the duration of the communication call; the Average Call Duration (ACD), or average length of the communication call on that communication network used compared to the ACD on other communication networks; the Call Answer Rate (ASR), or number of successfully answered communication calls on that communication network used; a numerical indication score, such as a Mean Opinion Score (MOS), of the communication call, which may be a subjective score provided by the first and second users; the number of short calls, i.e. communication calls shorter than few seconds, on that communication network used compared to other communication networks; and a call result indicating if the communication call has been dropped or hanged or if other communication calls between the first user and the second user has been repeated after the communication call, among other additional measurements that can help to determine communication call quality.

In an embodiment, the network quality indicator is computed by the communication application.

In another embodiment, the network quality indicator is computed by a telemetry server after the latter having received the information from the communication application or from the communication service. In this particular case, the computed network quality indicator can be further stored in a database for a later retrieval or use.

According to said described embodiments, each one of the quality parameters used in said information has an associated weight, which can be configured manually, e.g. by a user or system administrator, or determined automatically by the system. If the weights have been configured to be determined automatically, a machine learning algorithm can be used to find the optimal weight. The network quality indicator can be computed as the weighted sum, i.e. as the sum of the products of each of the quality parameters used and their corresponding weight. In this case, a minimum configurable threshold for each quality parameter used can be taken into account to indicate an “unsuitable” network quality indicator when at least one of the quality parameters is below the threshold. This threshold(s) can be configured either manually by the user or automatically. In this latter case a machine learning algorithm can be used to find the optimal thresholds.

In another embodiment, the computed network quality indicator is based on the average network signal strength during the communication call so the method segments the computed network quality indicator for different signal strengths intervals of said wireless network.

Moreover, in some embodiments, in order to compute the network quality indicator the telemetry server can further use information extracted from an additional communication call performed by another user (different to said second user) connected to the communication service through said communication network.

In yet other embodiments, the computed network quality indicator is used to determine whether the communication application registers to the communication service through the communication network, in this case, the first user can receive/perform further communication calls from/to at least the second user via a VoIP network.

In case the computed network quality indicator is above or equal a given threshold said registering is performed. On contrary, in case the computed network quality indicator is below a given threshold different alternatives may occur. In a first alternative, the communication application is the one determining that the computed network quality indicator is below the given threshold, and then the communication application may not request the registration to the communication service through said communication network; hence the first user will receive/perform further communication calls via a PSTN network. In a second alternative, the communication application request the registration and it is the communication service the responsible for determining that the computed network quality indicator is below the given threshold, and then the communication service may reject the registration, so the first user will also receive/perform further communication calls via a PSTN network. Finally, in a third alternative, the communication application request the registration, and it is again the communication service the one determining that the computed network quality indicator is below the given threshold but the communication service will accept this registration, but will inform the communication application that the computed network quality indicator is below the given threshold. In this latter alternative, the communication application can de-register from the communication service, and so, the first user can receive/perform further communication calls via a PSTN network.

The identifier of the communication network, for said wireless network, can be based on a WiFi-BSSID (Basic Service Set Identifier)), the Cell ID (CID) used in GSM networks, the Base Station ID (BID) used in CDMA networks, or the UTRAN/GERAN Cell Identity (UC-Id), which is a 32-bit value concatenating the Radio Network Controller (RNC) and Cell ID, used in WCDMA networks.

Alternatively, a network can be identified by a geographical area (e.g. a circle with a configurable radius). In this case location information of the computing device needs to be reported together with the communication call quality indicators. The location information can comprise the list of visible (i.e. detectable) wireless networks, for instance a list of BSSIDs, or even cell tower identifiers, and a cellular network connection indicator, for instance, the Cell ID (CID) used in GSM networks, the Base Station ID (BID) used in CDMA networks, or the UTRAN/GERAN Cell Identity (UC-Id).

Also an IP2Location™ web service can be used to determine the location of the device based on device's IP, if connected to a public communication network, or on a communication protocol, such as STUN, in order to discover its public IP address, in case it is connected behind NAT box.

According to another aspect of the invention software programs to perform the method embodiment steps and operations are also provided. More particularly, a computer program product is one embodiment that has a computer-readable medium including computer program instructions encoded thereon that when executed on at least one processor in a computer system causes the processor to perform the operations indicated herein as embodiments of the invention.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 is a general system architecture overview of all the elements, according to some embodiments, that can be used in the present invention for determining network quality indicators.

FIG. 2 is a flow diagram illustrating how the network quality is measured, according to some embodiments.

### DETAILED DESCRIPTION OF SEVERAL EMBODIMENTS

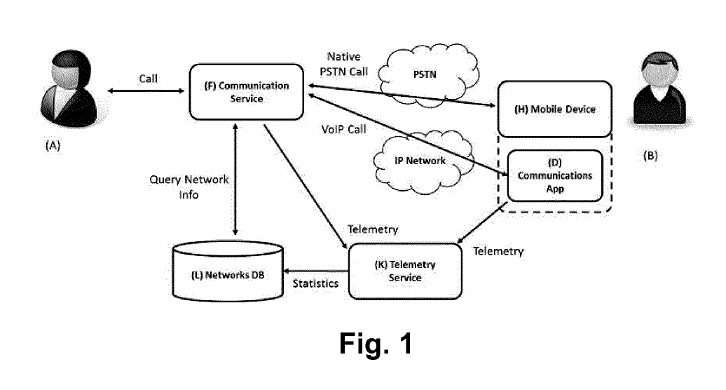

According to FIG. 1 the different elements that can be used for determining network quality indicators are: a communication service F, a telemetry server K, a database L and a user B mobile device H having installed therein a communication application D. For simplicity of the figure, the computing device used by user A for communicating with user B has not been illustrated.

According to an embodiment, once a communication call has been performed between user B and user A via the communication service F (in this case a VoIP communication service therefore the communication call performed between said two users being a VoIP call), the communication application D can keep an historical of said communication call over a configurable period of time (e.g. an hour, a day, a week, etc.), keeping an identifier of the communication network used (e.g. the WiFi-BSSID for a wireless network) and quality parameters concerning the communication call such as (only one is necessary): the duration of the communication call; a numerical indication describing if said communication call is a short call, an Average Call Duration (ACD) parameter; a Call Answer Rate (ASR) parameter; a numerical indication score of the communication call (e.g. a MOS); and a call result indicating if the communication call has been dropped or hanged, or if other communication calls between said two users B, A has been repeated after the communication call.

The communication application D then can loop over said historical and compute, by means of executing an algorithm running in a processor (not illustrated) and based on the information kept, a quality indicator descriptive of technical conditions of the communication network used for performing the communication call.

The quality for a same communication network, e.g. WiFi hotspot (identified by its network identifier) may vary significantly depending on the strength of the signal. Thus a same communication network may be very good for users located in the first floor of a building, in which the signal strength is high, but may be very bad for users located in the third floor in which the signal strength may be lower. Thus according to another embodiment, in particular when the computed network quality indicator comprises the average network signal strength during the communication call, the computed network quality indicator may be segmented for different signal strength intervals of the communication network.

Then, when communication application D is connected to a known IP communication network (determined by its network identifier) if the network quality indicator is known for that IP communication network and is below a configurable threshold, communication application D can choose not to register to this IP communication network for VoIP communication calls (optionally asking user B to approve), or signal the communication service F to prefer a PSTN calling (for example by setting PrefersVoIP parameter, as described in the co-pending patent application EP14382310 of the same applicant of present invention, during registration in REGISTER to OFF.

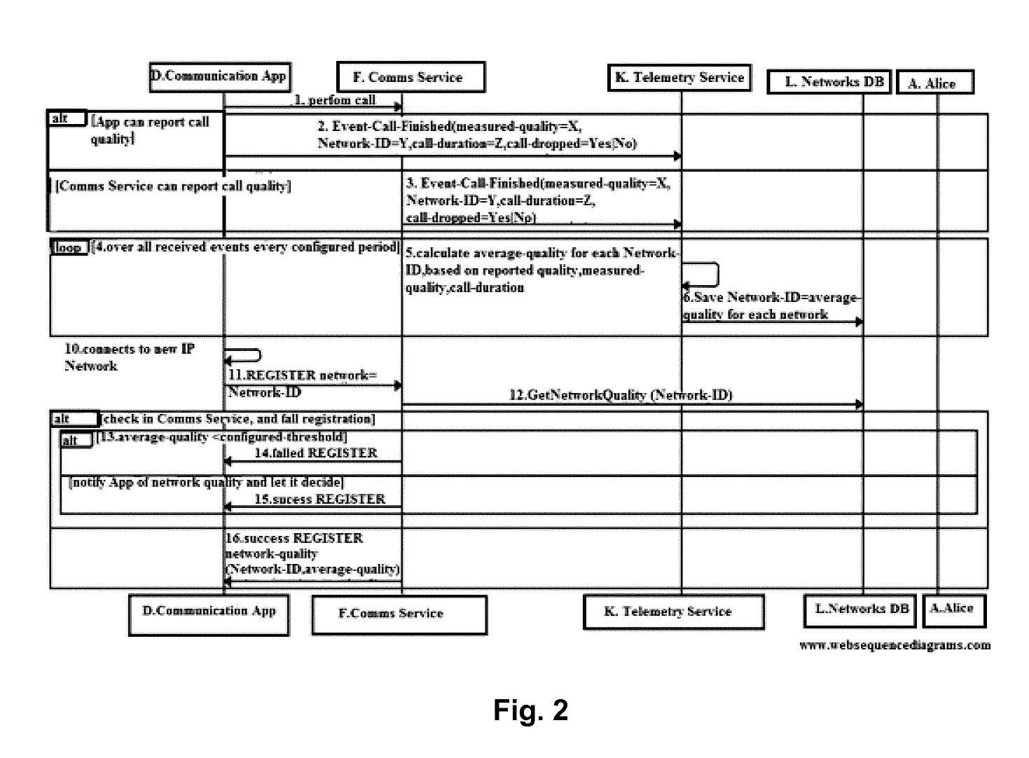

FIG. 2 illustrates another embodiment of the present invention, in this case once the VoIP communication call is completed (1), communication application D sends (2) the information kept (extracted) from said VoIP communication call (i.e. the network identifier and the quality parameter(s)) to the telemetry server K. Alternatively, the information extracted from the VoIP communication call can be generated by the communication service F itself, and sent (3) to the telemetry server K. This alternative works when the actual call media passes through the network communication service F, so that the communication service F can keep the parameters needed for the quality measurement. For instance, this alternative is not possible, when call media is handed off and connected directly between the communication application D of the called and the caller, such as in WebRTC, or other peer-to-peer networks.

An analytical unit of the telemetry server K that has at least one processor executing an algorithm can then loop every configurable interval (e.g. 1 week) and compute the network quality indicator. As amount of the events from multiple communication applications may be very large, techniques, such as map reduce can be applied, incrementally aggregating network quality events, and eventually reaching the computed network quality indicator for each network. Telemetry server K then saves the computed network quality indicator (6) in a network database (L).

Each quality parameter has an associated weight, which can be automatically determined or manually configured. In the case the weight(s) is(are) automatically determined a machine learning algorithm may be used to find the optimal weight(s). The network quality indicator which as described before may be computed either by the communication application D or by the telemetry server K is computed, in accordance with an embodiment, as the weighted sum of the products of each of the quality parameters used and their corresponding weight.

Moreover, the communication application D or the telemetry server K can indicate that the computed network quality indicator is “unsuitable” if at least one of the quality parameters is below a configurable minimum threshold. It has to be noted that the weight may be positive or negative, as some of the quality parameters are better are they are higher, whereas others (number of short calls, number of dropped calls) are better if they are lower. Apart from that, the minimum threshold can be configured manually or automatically, for example using also machine learning algorithms, that find optimal thresholds corresponding to subjective user perception of quality calls.

The telemetry server K, according to other embodiments, to compute the network quality indicator can also use information extracted from other additional VoIP communication calls performed by other users connected to the communication service F through the communication network.

To manage network preferences from the mobile communication application D, when communication application D detects connection to a new IP communication network, it needs to register to a VoIP Service, which can be done for example by sending REGISTER SIP request and include the communication network identifier in the request and optionally indicate, this communication network as preferred for receiving VoIP communication calls (e.g. by sending PrefersVoIP=ON as described in the co-pending patent application EP14382310), based on previously known network quality or user preferences.

Communication service F, then queries (12) the database L to retrieve the computed network quality indicator for the communication network identifier specified by the communication application D in the registration request. In some embodiments the signal strength level of the network (in case of a wireless network, e.g. WiFi) may be also reported, so that the retrieved computed network quality indicator is specific for the corresponding signal strength interval.

There are different options to handle communication networks when the computed network quality indicator has low quality (poor technical conditions)—in the communication service F or in the communication application D. For instance, in a first option, the communication application D can check (13) that the computed network quality indicator is below the configurable threshold, and in this case may decide not to request registration to the communication service F through that communication network. In a second option the communication service F can be the one that checks (13) that the received computed network quality indicator is below the configurable threshold, in this case, the communication service F rejects the registration request of the communication application D (e.g. SIP REGISTER), sending (14) a fail result to the communication application D. If on the contrary the computed network quality indicator was ok, the communication service will allow (15) the registration. In a third option, the communication Service F always allows the REGISTER request, including (16) the computed network quality indicator in the response (or sending a separate message after REGISTER response) to the communication application D. Communication application D then receives the response/message with the computed network quality indicator, and can decide to unregister from VoIP network completely or to re-register with a different preference (for example by including PrefersVoIP=OFF or ON as described in the co-pending patent application EP14382310), depending on whether the received computed network quality indicator is below or above the configurable threshold.

While the foregoing is directed to embodiments of the present invention, other and further embodiments of the invention may be devised without departing from the basic scope thereof. For example, other aspects may be implemented in hardware or software or in a combination of hardware and software.

Additionally, the software programs included as part of the invention may be embodied in a computer program product that includes a computer useable medium. For example, such a computer usable medium can include a readable memory device, such as a hard drive device, a flash memory device, a CD-ROM, a DVD/ROM, or a computer diskette, having computer readable program code segments stored thereon. The computer readable medium can also include a communications link, either optical, wired, or wireless, having program code segments carried thereon as digital or analog signals. The scope of the present invention is determined by the claims that follow.

The scope of the invention is defined by the attached claims.

1. A computer implemented method for determining network quality indicators, comprising:
performing at least one communication call, between a first user (B) having a mobile device (H) with a communication application (D) installed therein which is connected to a VoIP communication service (F) through a communication network with at least a second user (A) via said communication service (F); and
computing, based on information extracted from said at least one communication call, by means of executing an algorithm running in a processor, a quality indicator descriptive of technical conditions of said communication network used for performing the at least one communication call,
wherein said information is extracted from the at least one communication call by the communication application (D) or by the communication service (F) and includes at least one of an identifier of the communication network used or location information of the mobile device (H) during the communication call, and quality parameters related to the at least one communication call including at least one of:
the duration of the communication call;
an Average Call Duration, or ACD;
a Call Answer Rate, or ASR;
a numerical indication describing if the communication call being a short call;
a numerical indication score of the communication call; and
a call result indicating if the communication call has been dropped or hanged, or if other communication calls between the first user (B) and the second user (A) has been repeated after the communication call.

2. The computer implemented method of claim 1, wherein the network quality indicator is computed by the communication application (D).

3. The computer implemented method of claim 1, wherein the network quality indicator is computed by a telemetry server (K) after the telemetry server (K) having received said information from the communication application (D) or from the communication service (F).

4. The computer implemented method of claim 1, wherein each one of the quality parameters used for said information has an associated weight, automatically determined or manually configured, wherein if the weight(s) is(are) automatically determined the method comprises using a machine learning algorithm to find an optimal weight, wherein the network quality indicator is computed by performing the sum of the products of each of the quality parameters used and their corresponding weight.

5. The computer implemented method of claim 4, wherein a minimum configurable threshold is determined for each quality parameter used, wherein each threshold is automatically determined or manually configured, wherein if automatically determined a machine learning algorithm is used to find the optimal threshold, wherein an unsuitable network quality indicator is determined when at least one of the quality parameters is below its corresponding threshold.

6. The computer implemented method of claim 1, wherein the communication network is a wireless network.

7. The computer implemented method of claim 6, wherein the computed network quality indicator comprises an average network signal strength during the communication call, and the method further comprising segmenting the computed network quality indicator for different signal strengths intervals of said wireless network.

8. The computer implemented method of claim 3, in which information extracted from at least one additional communication call performed by at least one additional user connected to said communication service (F) through said communication network is used to compute the network quality indicator.

9. The computer implemented method of claim 1, further comprising using the computed network quality indicator to determine whether said communication application (D) registers to said communication service (F) through said communication network in order the first user (B) receiving/performing further communication calls from/to at least the second user (A) via a VoIP.

10. The computer implemented method of claim 9, comprising registering the communication application (D) to the communication service (F) through said communication network if the computed network quality indicator is above or equal a given threshold.

11. The computer implemented method of claim 9, wherein in case the computed network quality indicator is below a given threshold, the communication application (D) does not request the registration to the communication service (F) through said communication network, and the first user (B) comprising receiving/performing further communication calls via a PSTN network.

12. The computer implemented method of claim 9, wherein in case the computed network quality indicator is below a given threshold, the communication service (F) comprising rejecting the registration of the communication application (D) through the communication network, and the first user (B) comprising receiving/performing further communication calls via a PSTN network.

13. The computer implemented method of claim 9, wherein the communication service (F), in case the computed network quality indicator is below a given threshold, comprises:
accepting the registration of the communication application (D) through said communication network, and
informing the communication application (D) that the computed network quality indicator is below the given threshold.

14. The computer implemented method of claim 13, further comprising de-registering, the communication application (D) from the communication service (F), and the first user receiving/performing further communication calls via a PSTN network.

15. A computer program product comprising executable instructions that, when executed by one or more processors of a computer system, cause the computer system to perform the method of claim 1.
